(19) United States
(12) Patent Application Publication
(10) Pub. No.: US 2003/0153646 A1
(43) Pub. Date: Aug. 14, 2003

(54) Spacer fluids for well cementing operations

(76) Inventors: Matteo Loizzo, Paris (FR); Edgar Volpert, Munchen (DE)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(21) Appl. No.: 10/285,159

(22) Filed: Oct. 31, 2002

(30) Foreign Application Priority Data
Nov. 13, 2001 (FR) FR 01 14751

(51) Int. Cl. C08K 3/18; C09K 7/00

(52) U.S. Cl. 523/130; 524/433

(57) ABSTRACT

A spacing fluid or “spacer”, of the type comprising a fluid and particles, notably particles of loading agent, as well as possibly normal additives, such as a viscosity-increasing polymer, for separating a cement slurry from borehole fluids during a well cementing operation, characterised in that the spacing fluid has a density close that of the drilling fluid or mud and a viscosity close to that of water, by virtue of the adaptation of the size of the particles to a value less than 5 microns, particularly around 2 to 3 microns or around 0.2 to 0.3 microns, such as by the use of magnesium oxide or rutile.

### FIELD OF THE INVENTION

The present invention relates to the field of well cementing operations and in particular to spacer fluids for use in such operations.

### BACKGROUND OF THE INVENTION

When an oil well is drilled, a drilling fluid (often called “drilling mud”) is circulated in the well. The main purposes of the fluid are to lubricate the drilling operation, to control the hydrostatic pressure in the well and to convey the debris (drilling cuttings, etc.) to the surface and out of the hole. At certain point during the drilling operation, a tubular element or “casing” is lowered into the drilling hole and cemented by pumping a cement slurry through the casing and into the annular space (annulus) existing between the casing and the borehole wall where it is allowed to set. This provides good isolation of the formations through which the borehole passes. Normally a flushing or preflushing fluid is pumped through the well before pumping the cement slurry. This flushing fluid (which is also generally referred to by the term “spacing fluid” or “spacer”) has two main purposes: to drive out the drilling fluid which is initially situated in the annulus, and to separate the cement slurry and the drilling fluid since in general these two fluids are incompatible and mixing of the two can lead to problems, especially in the setting and set properties of the cement. In order to be capable of fulfilling these purposes, the fluid present between the drilling mud and the cement slurry must maintain stable interfaces between the different fluids and must clean the walls of the borehole before the cement is placed. In order to obtain the good zonal isolation required, the fluid must completely displace the drilling fluid and must remove all the residues from the surface of the casing and of the wall of the drilling hole, making it possible to obtain good bonding between the cement and the formation and between the cement and the casing.

The most effective way of completely cleaning the drilling hole consists in pumping the flushing fluid (“preflush”) in a turbulent flow mode, that is to say pumping the fluid under conditions above the critical rate of flow to generate turbulence. Knowing whether a fluid is situated in turbulent flow depends on the Reynolds number Rₑ, which is defined for a Newtonian fluid circulating in a pipe by the formula Rₑ=ρVD/η (in which ρ=density of the fluid, V=speed of the fluid, D=diameter of the pipe, η=viscosity of the fluid). Similar equations can be established for fluids having a more complicated theological profile (for example profiles according to Bingham or Herschel-Bulkley). In all cases, the Reynolds number will increase if the viscosity of the fluid is reduced, that is to say, the lower the viscosity of the fluid, the easier it will be to bring the fluid into a turbulent flow state. Between the laminar flow regime and the turbulent flow regime there exists a transition zone which commences at approximately Re=2100-2500 and ends at approximately 3000-8000 according to the fluid. The fluid is typically pumped at a flow rate such that the fluid is situated in a total turbulent state in order to effect a complete cleaning of the borehole.

Often, the critical flow rate cannot be implemented on site since the maximum pump rates are limited because of the performance of well-site equipment and also because of the fact that excessive flow rates can create friction pressures which can the formation through which the borehole passes by pressure effects. Thus, in order to obtain a critical turbulence flow rate which is very low, the rheology of the fluid must be maintained at a value which is as low as possible. Pure water would therefore be an ideal candidate as a fluid of this type, because of its low viscosity. However, one of the requirements for the flushing fluid is to have an appropriate density for the pumping operation and consequently, in general terms, the fluid is weighted by an addition of a loading agent such as barite. The density of the fluid is important for two reasons:

control of the well is ensured only if the weight of the fluid column at a given point in the well balances the pressure of fluids in the formation surrounding the well at this point (for example pumping water may lead to an influx of formation fluid if the hydrostatic pressure is below the formation pressure which, if uncontrolled, may lead to a blow out);

the difference in density between the fluids may create instabilities in flow at the fluid-fluid interfaces, in particular in deviated (non-vertical) wells: light fluids will have a tendency to flow over the top part of the annular space and of the well, leaving a thicker layer of drilling fluid behind the interface, thus resulting in incomplete cleaning of the drilling hole.

The presence of loading agent in the fluid means that it is necessary to add a viscosity-increasing polymer in order to stabilize the suspension of particles by creating a yield stress. This has the drawback of increasing the critical flow rate because of the increased viscosity of the fluid. Designing a spacing fluid or “spacer” consequently consists in finding a minimum concentration of polymer at which the particles remain in suspension, but at which, simultaneously, the viscosity is sufficiently low to make it possible to achieve turbulent flow conditions. However, this minimum value is often not sufficiently low to make it possible to achieve the flow rate necessary for turbulent flow under normal operating conditions.

According to the hydrostatic conditions, one way of pumping at least some of the preflush fluid between the mud and the cement slurry, in turbulent flow, and satisfying the density requirements for the column of fluid, comprises separating the preflush fluid into two parts: one part consists of a small volume of a non-loaded fluid, and the other part consists of a loaded fluid. This has traditionally led to the subdivision of the preflush fluids into two categories: washing fluids (“washes”) and spacing fluids (“spacers”). The washing fluids are normally water (or light brines) or a basic oil having an extremely low viscosity (approximately 1 mPa*s) and a high degree of turbulence, whilst the spacing fluids or “spacers” are viscous loaded fluids, whose rheology is very often too high to actually achieve turbulence.

### SUMMARY OF THE INVENTION

The present invention provides to a novel spacing fluid or “spacer” of the type comprising a liquid component and a solid particulate component, in particular particles of loading agent, as well as possibly various normal additives, such as a viscosity-increasing polymer, in order to separate the cement slurry from the other borehole fluids during a well cementing operation, characterized in that the spacing fluid has a density close to that of the borehole fluids and a viscosity close to that of water.

According to one embodiment, the fluid is characterized in that the choice of particles is adapted to obtain a density close to that of the borehole fluids and a viscosity close to that of water.

According to another embodiment, the fluid is characterized in that the particle size is adapted to obtain a density close to that of the borehole fluids and a viscosity close to that of water.

The choice of particles, and in particular the particle size, makes it possible to design spacing fluids having a density close to that of the borehole fluids and a viscosity close to that of water. This has several advantages, compared with the spacing fluids which are normally pumped:

a “preflush” fluid, consisting of two different fluids, is replaced with a single low-viscosity loaded fluid;

the critical flow rate is reduced and the degree of turbulence is increased for a particular flow rate; and

the density of the spacing fluid can be increased up to the original density of the drilling fluid without its viscosity increasing.

For preparing spacing fluids or “spacers”, barite (barium sulfate) is normally used, which generally has a particle size situated in the 20-30 micron range. An increased viscosity of the fluid is necessary to ensure that these particles remain in suspension. By selecting loading particles with a smaller particle size it possible to reduce or even avoid the addition of viscosity-increasing polymers. Through a precise choice of the particle size of an inert loading agent, it is thus possible to merge the two categories of spacing fluids (“spacers”), which were previously incompatible, and to effectively decouple density and viscosity.

The invention therefore relates to a fluid as described here, and characterized in that the size of the particles is below 5 microns and in particular characterized in that the size of the said particles is around 2 to 3 microns and more particularly characterized in that the size of the said particles is around 0.2 to 0.3 microns.

In general terms, it is possible to employ metal oxides with a particle diameter <5 microns. According to a particular embodiment, the loading particles can be magnesium oxide (Micromax™, particle size: 2-3 microns).

According to another particular embodiment, the loading particles are rutile (titanium oxide, TiO2, particle size: 0.2-0.3 microns).

The viscosity-increasing polymer can be added in the minimum quantity for obtaining stable suspensions, that is to say an absence of appreciable sedimentation for at least two hours. According to the preferred embodiment, the polymer is a welan gum (Biozan™). Up to 0.2% by weight of polymer can be used, preferably around 0.075% by weight of welan gum when the Micromax™ agent is used, and up to 0.1% by weight of welan gum when the rutile agent is used.

Other viscosity-increasing agents which could be used are gelan gum, modified guar gum, scleroglucane and clays (such as bentonite).

### DESCRIPTION OF PREFERRED EMBODIMENTS

Results: In order to demonstrate the efficacy of reducing the viscosity of the fluid and therefore the critical speed by reducing the particle size, three different types of particle are used: barite with a particle size of 20-30 microns, magnesium oxide (Micromax™, particle size: 2-3 microns), and rutile (titanium oxide, TiO2, particle size: 0.2-0.3 microns). Welan gum (Biozan™) is chosen to stabilize the suspensions. In all cases, the minimum quantity of welan making it possible to obtain stable suspensions is added to the fluid. In the present application, the term “stability” means that the suspension will exhibit no significant phenomenon of sedimentation for at least two hours. This criterion is important in order to avoid the deposition or sedimentation of particles during unexpected stoppages in pumping occurring, and also in order to ensure that, for the period of time which elapses between the mixing of the fluid and its pumping at the surface, no sedimentation occurs in the storage vessel, even in cases where stirring is insufficient. A period of two hours is generally amply sufficient to result in the necessary safety. The amount of welan gum used is 0.15% by weight for barite and 0.075% by weight for Micromax™. Rutile requires no addition of viscosity-increasing polymer in order to result in stable suspensions although is may be desirable to add such materials when other solid additives are present. For all types of particle, fluids with three different densities are prepared. The formulations and the results of the rheological measurements are shown in Tables 1-3. All the rheological data are measured using a Fann™ 35 apparatus. The data are established on two different models: the Bingham model and the Herschel-Bulkley model. The results show that a considerable reduction in the viscosity of the fluid is obtained when finer particles than the usual barite are used for the preparation of stable suspensions.

Tables 4 and 5 indicate the critical speeds or rates for the various fluids, in a well having a diameter of opening of the drilling hole of 6.5″ (16.7 cm) and a casing of 5″ (12.8 cm) at temperatures of 25 and 85° C. Three different critical speeds are calculated: QC, Trans, 100% and QC, Turb, 100% are the critical speeds for a casing perfectly centered at the start and end of the transition zone between laminar flow and turbulent flow, respectively; QC, Turb, 75% is the critical speed for total turbulence conditions with a casing centralization of 75% (the centralization or “stand-off” (STO) is a measurement of the centering of the casing in the drilling well. It is defined by the formula %STO=(W/(RH−RC))×100 in which W=the narrowest space between the casing, and in which RH and RC are the respective radii of the drilling hole and casing. Thus a 100% STO centralization designates a centralization which is perfect, whilst a centralization value STO of 0% indicates contact between the casing and the formation). The critical speeds or rates are calculated on the basis of the theological values obtained in the Herschel-Bulkley model. The results demonstrate that reducing the particle size makes it possible to considerably reduce the critical turbulence condition speed or rate. If the basic barite and rutile fluids are compared, the speeds or rates corresponding to turbulence may be reduced by a factor of 50% or more.

Table 6 presents the sedimentation results for the various fluids. The measurements are made by pouring the suspensions into a graduated 100 ml cylinder. The densities are measured by weighing 10 ml samples from the top part and the bottom part of the sample. Whilst none of the fluids exhibits water separation at the top of the column, nor visually obvious sedimentation of particles after two hours at 85° C., a density gradient exists in the fluids based on barite and Micromax™. Whilst in the last of these fluids the gradient is relatively limited, the first of these fluids exhibits a high tendency towards sedimentation. In order to prevent this, it is necessary to increase the viscosity, which results in a further increase in the critical speeds. On the other hand, the fluid based on rutile exhibits absolutely no sedimentation.

The invention also relates to the methods for cementation of an oil drilling, geothermal or similar well, characterized in that a spacing fluid or “spacer” as defined above is used. The invention also covers the equivalent techniques which will come directly to the mind of a person skilled in the art from reading the present application.

TABLE 1
Rheologies for spacing fluids or “spacers” based on barite with three different densities
measured by means of a Fann ™ 35 viscometer at 25 and 85° C.. The data
have been adapted to the Bingham model (τ = τy + η,γ) and the Herschel-Bulkley
model (τ = τy + η,γν).

| Fluid code | BA1 | | BA2 | | BA3 | |
|---|---|---|---|---|---|---|
| Density/specific gravity S.G | 1.26 (10.5) | | 1.50 (12.5) | | 1.68 (14) | |
| (ppg) | | | | | | |
| Anti-foaming agent | 3.6 g/l | | 3.6 g/l | | 3.6 g/l | |
| Welan gum/in terms of weight | 0.15 | | 0.15 | | 0.15 | |
| of water | | | | | | |
| Dispersant/% by weight of | 0.7 | | 0.7 | | 0.7 | |
| barite | | | | | | |
| | 25° C. | 85° C. | 25° C. | 85° C. | 25° C. | 85° C. |
| Rheology | | | | | | |
| 300 | 10.0 | 7.0 | 15.5 | 11.0 | 22.0 | 14.0 |
| 200 | 7.5 | 6.0 | 12.0 | 8.5 | 16.5 | 11.0 |
| 100 | 5.5 | 4.5 | 8.0 | 6.5 | 11.0 | 8.0 |
| 60 | 5.0 | 3.5 | 6.0 | 5.0 | 8.5 | 6.5 |
| 30 | 4.0 | 3.0 | 5.0 | 4.0 | 6.5 | 5.0 |
| 6 | 2.5 | 2.0 | 35.0 | 2.5 | 3.5 | 3.0 |
| 3 | 2.0 | 1.5 | 3.0 | 2.0 | 3.0 | 2.5 |
| Bingham model | | | | | | |
| τ_{y}/Pa | 1.4 | 1.1 | 1.8 | 1.4 | 2.0 | 1.8 |
| PV/mPa. S | 7.4 | 5.3 | 12.4 | 8.6 | 18.7 | 11.1 |
| Herschel-Bulkley model | | | | | | |
| τ_{y}/Pa | 0.9 | 0.5 | 1.8 | 0.8 | 1.27 | 0.94 |
| K/Pa. sⁿ | 0.09 | 0.13 | 0.01 | 0.11 | 0.1 | 0.15 |
| N | 0.61 | 0.51 | 1.0 | 0.6 | 0.73 | 0.6 |

TABLE 2
Rheologies for spacing fluids or “spacers” based on Micromax (MgO2) with thrée
different densities measured by means of a Fann ™ 35 viscometer at 25 and 85° C..
The data have been adapted to the Bingham model (τ = τy + η, γ) and
the Herschel-Bulkley model (τ = τy + η, γn).

| Fluid code | MA1 | | MA2 | | MA3 | |
|---|---|---|---|---|---|---|
| Density/specific gravity S.G | 1.26 (10.5) | | 1.50 (12.5) | | 1.68 (14) | |
| (ppg) | | | | | | |
| Anti-foaming agent | 3.6 g/l | | 3.6 g/l | | 3.6 g/l | |
| Welan gum/in terms of weight | 0.75 | | 0.75 | | 0.75 | |
| of water | | | | | | |
| Dispersant/% by weight of | 0.7 | | 0.7 | | 0.7 | |
| Micromax ™ | | | | | | |
| | 25° C. | 85° C. | 25° C. | 85° C. | 25° C. | 85° C. |
| Rheology | | | | | | |
| 300 | 7.5 | 4.5 | 12.5 | 8.5 | 13.5 | 13.0 |
| 200 | 5.5 | 4.0 | 9.5 | 6.5 | 10.0 | 11.0 |
| 100 | 4.0 | 2.5 | 6.0 | 4.5 | 6.5 | 7.0 |
| 60 | 3.0 | 2.0 | 4.5 | 3.5 | 4.5 | 4.5 |
| 30 | 2.0 | 1.5 | 3.0 | 2.5 | 3.0 | 2.5 |
| 6 | 1.5 | 1.0 | 1.5 | 1.5 | 1.5 | 1.0 |
| 3 | 1.0 | 0.5 | 1.0 | 1.0 | 1.0 | 0.5 |
| Bingham model | | | | | | |
| τ_{y}/Pa | 0.7 | 0.3 | 0.8 | 0.8 | | 0.7 |
| PV/mPa. S | 6.2 | 1.6 | 11.4 | 12.4 | | 12.9 |
| Herschel-Bulkley model | | | | | | |
| τ_{y}/Pa | 0.4 | 0.0 | 0.3 | 0.4 | 0.34 | 0 |
| K/Pa. sⁿ | 0.04 | 0.102 | 0.07 | 0.07 | 0.07 | 0.12 |
| N | 0.73 | 0.38 | 0.71 | 0.65 | 0.74 | 0.65 |

TABLE 3
Rheologies for spacing fluids or “spacers” based on rutile with three different densities
measured by means of a Fann ™ 35 viscometer at 25 and 85° C.. The data have been
adapted to the Bingham model (τ = τy + η, γ) and the Herschel-Bulkley model
(τ = τy + η, γν).

| Fluid code | RU1 | | RU2 | | RU3 | |
|---|---|---|---|---|---|---|
| Density/specific gravity S.G | 1.26 (10.5) | | 1.50 (12.5) | | 1.68 (14) | |
| (ppg) | | | | | | |
| Anti-foaming agent | 3.6 g/l | | 3.6 g/l | | 3.6 g/l | |
| Welan gum/in terms of weight | — | | — | | — | |
| of water | | | | | | |
| Dispersant/% by weight of | 0.65 | | 0.65 | | 0.65 | |
| rutile | | | | | | |
| | 25° C. | 85° C. | 25° C. | 85° C. | 25° C. | 85° C. |
| Rheology | | | | | | |
| 300 | 3.0 | 2.0 | 5.0 | 4.5 | 10.0 | 9.0 |
| 200 | 2.5 | 1.75 | 3.5 | 3.5 | 7.5 | 7.0 |
| 100 | 2.0 | 1.5 | 2.0 | 2.5 | 4.5 | 4.5 |
| 60 | 1.5 | 1.25 | 1.5 | 2.0 | 3.0 | 3.5 |
| 30 | 1.0 | 0.75 | 1.0 | 1.25 | 1.5 | 2.5 |
| 6 | 0.75 | 5.0 | 0.75 | 1.0 | 0.8 | 1.5 |
| 3 | 0.5 | 0.25 | 0.5 | 0.5 | 0.5 | 1.0 |
| Bingham model | | | | | | |
| τ_{y}/Pa | 0.4 | 0.3 | 0.3 | 0.5 | 0.4 | 0.8 |
| PV/mPa. S | 2.4 | 1.6 | 4.4 | 3.8 | 9.7 | 7.8 |
| Herschel-Bulkley model | | | | | | |
| τ_{y}/Pa | 0.1 | 0.0 | 0.3 | 0.21 | 0.09 | 0.42 |
| K/Pa. sⁿ | 0.07 | 0.1 | 0.004 | 0.044 | 0.04 | 0.05 |
| N | 0.48 | 0.38 | 1.0 | 0.62 | 0.78 | 0.7 |

TABLE 4
Pumping speed or rate making it possible to achieve turbulence for the
three different types of fluid at three different densities at 25° C.
All the calculations are made for a 5″ (12.8 cm) casing in a 6.5″
(16.7 cm) drilling well. (QC, Trans, 100%, QC, Turb, 100% = critical
flow at the start and end of the transition zone at a centralization
STO of 100%, QC, Turb, 75% = critical flow for
a total turbulence at STO of 75%).

| 25 deg C. | Density (S.G) | Q_{c,Trans,100%} | Q_{c,Turb,100%} | Q_{c,Turb,75%} |
|---|---|---|---|---|
| BA1 | 1.26 | 3.8 | 4.8 | 6.7 |
| MA1 | 1.26 | 2.8 | 3.8 | 5.4 |
| RU1 | 1.26 | 1.8 | 2.3 | 3.1 |
| BA2 | 1.50 | 4.0 | 5.4 | 8.1 |
| MA2 | 1.50 | 3.4 | 4.8 | 7 |
| RU2 | 1.50 | 1.4 | 1.9 | 2.8 |
| BA3 | 1.68 | 4.9 | 6.8 | 9.9 |
| MA3 | 1.68 | 3.3 | 4.7 | 6.9 |
| RU3 | 1.68 | 2.4 | 3.6 | 5.4 |

TABLE 5
Pumping speed or rate making it possible to achieve turbulence for the
three different types of fluid at three different densities at 25° C..
All the calculations are made for a 5″ (12.8 cm) casing in a 6.5″
(16.7 cm) drilling well. (QC, Trans, 100%, QC, Turb, 100% = critical
flow at the start and end of the transition zone at a centralization
STO of 100%, QC, Turb, 75% = critical flow for
a total turbulence at STO of 75%).

| 85 deg C. | Density (S.G) | Q_{c, Trans,100%} | Q_{c, Turb,100%} | Q_{c, Turb,75%} |
|---|---|---|---|---|
| BA1 | 1.26 | 3.2 | 3.9 | 5.4 |
| MA1 | 1.26 | 2.0 | 2.6 | 3.5 |
| RU1 | 1.26 | 1.5 | 1.8 | 2.5 |
| BA2 | 1.50 | 3.6 | 4.6 | 6.4 |
| MA2 | 1.50 | 2.8 | 3.7 | 5.3 |
| RU2 | 1.50 | 1.9 | 2.4 | 3.4 |
| BA3 | 1.68 | 3.9 | 5.0 | 7.0 |
| MA3 | 1.68 | 3.4 | 4.8 | 7.0 |
| RU3 | 1.68 | 2.6 | 3.5 | 5.1 |

TABLE 6
Results of the sedimentation tests at 85° C.. All the tests are carried out by
pouring the preheated suspension into a graduated 100 ml glass cylinder.
The cylinder is sealed and kept in an oven at 85° C. for two hours. Next
the cylinder is cooled and 10 ml samples taken from the top and bottom
using a graduated glass pipette. Table 6 indicates the weight
of the various samples.

| | SG = 1.26 | | SG = 1.50 | | SG = 1.68 | |
|---|---|---|---|---|---|---|
| | Top | Bottom | Top | Bottom | Top | Bottom |
| BA g/10 ml | 10.8 | 13.8 | 13.4 | 15.8 | 16.1 | 16.6 |
| MA g/10 ml | 11.9 | 12.8 | 14.7 | 15 | 16.3 | 16.4 |
| RU g/10 ml | 12.4 | 12.4 | 14.7 | 14.7 | 16.6 | 16.7 |

We claim:

1 A spacer fluid for use in well cementing operations for separating a cement slurry from other fluids present in a well, comprising: a mixture of a liquid component and a solid component comprising a particulate loading agent having a particle size of less than 5 microns, the mixture having a density close to that of the drilling fluid or mud and a viscosity close to that of water.

2 A spacer fluid as claimed in claim 1, wherein the particle size of the loading agent is around 2-3 microns.

3 A spacer fluid as claimed in claim 2, wherein the loading agent comprises magnesium oxide particles.

4 A spacer fluid as claimed in claim 1, wherein the particle size of the loading agent is around 0.2-0.3 microns.

5 A spacer fluid as claimed in claim 4 wherein the loading agent comprises titanium oxide.

6 A spacer fluid as claimed in claim 1, further comprising a polymer gel as a viscosity increasing additive.

7 A spacer fluid as claimed in claim 1, further comprising a clay as a viscosity increasing additive.

8 A spacer fluid as claimed in claim 6, wherein the polymer gel is selected from the group consisting of welan gum, gelan gum, modified guar gum, and scleroglucane.

9 A spacer fluid as claimed in claim 6, wherein the polymer gel is present in a quantity sufficient to obtain stable suspensions having an appreciable absence of sedimentation for at least two hours.

10 A spacer fluid as claimed in claim 3, further comprising up to 0.3%, by weight of welan gum polymer as a viscosity increasing additive.

11 A spacer fluid as claimed in claim 10, comprising about 0.075% by weight of welan gum polymer.

12 A spacer fluid as claimed in claim 5, further comprising up to 0.2% by weight of welan gum polymer as a viscosity increasing agent.
